(19) United States
(12) Patent Application Publication
(10) Pub. No.: US 2007/0104428 A1
(43) Pub. Date: May 10, 2007

(54) AUTOMATED PROCESS FOR EMBEDDING OPTICAL FIBERS IN FIBERGLASS YARNS

(76) Inventors: Keith Goossen, Howell, NJ (US); Eric Dean Wetzel, Baltimore, MD (US); David Louis Fecko, State College, PA (US)

Correspondence Address: Connolly Bove Lodge & Hutz LLP, P.O. Box 2207, Wilmington, DE, 19899-2207, US

(21) Appl. No.: 11/557,629

(22) Filed: Nov. 8, 2006

Related U.S. Application Data
(60) Provisional application No. 60/734,849, filed on Nov. 9, 2005.

(51) Int. Cl. G02B 6/44

(52) U.S. Cl. 385/101

(57) ABSTRACT

An automated process for embedding optical fiber in fiberglass yarn is presented. The process permits fabricating a spool in a single, automated step in a conventional yarn spooling apparatus.

### CROSS REFERENCE TO RELATED APPLICATION

This application is based on provisional application Ser. No. 60/734,849, filed Nov. 9, 2005, all of the details of which are incorporated herein by reference thereto.

### GOVERNMENT LICENSE RIGHTS

The United States government has rights to this invention which was done under funding by Army Research Laboratory, grant DAAD 19-01-2-0001.

### BACKGROUND OF INVENTION

Composite materials composed of woven fabrics embedded in polymeric resin are finding increased usage in a variety of structural applications. Additionally their construction allows for embedding of optical fibers for sensing or communication. Until recently optical fibers have been embedded in composites manually or semi-automatically, which while useful for laboratory experiments is not appropriate for mass production.

### SUMMARY OF INVENTION

The present invention relates to a completely automated process for embedding optical fibers in a fiberglass yam, which could be used as a yarn in textile processes, allowing automated embedding of optical fibers in textiles and woven composites.

### THE DRAWINGS

The single figure is a schematic showing of the optical yarn fabrication process in accordance with this invention.

### DETAILED DESCRIPTION

### 1. Introduction

Reference is made to concurrently filed patent application Ser. No. ______, entitled An Automated Process for Embedding Optical Fibers in Woven Composites based upon provisional application Ser. No. 60/734,940, filed Nov. 9, 2005, all of the details of which are incorporated herein by reference thereto.

Two application areas necessitate embedding optical fibers into structural fiber-reinforced polymer composites: sensing and communication. For sensing applications, optical sensors provide a compact, low-power means for transducing properties such as temperature, strain, and degree of cure. This information, in turn, can then be used to judge the health of a structure, interrogate the conditions of the surrounding environment, or monitor and adjust the process conditions during fabrication of the composite [1-9]. By coupling many optical fiber sensors into a distributed sensor network, a rich data set is generated which can be used to assess the global conditions of a composite structure.

For communication applications, the optical fiber acts as a conduit which transmits data between points on the structure. By necessity, optical sensors include fiber optic leads which allow communication between the sensor and the optical conditioning source. In simpler communication applications, information is transmitted into the composite structure, shuttled along the composite to another location, and then transmitted out of the composite and into a receiver. These integral communication conduits can replace conventional data conduits, such as metallic wiring and optical cabling, on conventional composite structures such as air and ground vehicles, ships, spacecraft, and civil structures. Embedding the optical fiber into the structure provides a number of advantages, such as lower weight, more compact packaging, manufacturing simplicity through simplification of wire routing, and the creation of robust networks through redundant optical pathways.

The optical data networks required for structural composites offer two characteristics which make their implementation different than the design of conventional communication networks. First, the typical transmission length is only tens of meters, rather than the hundreds of kilometers which can be traversed by traditional optical networks. These shorter distances permit higher linear signal loss, which allows for the use of lossier conduit materials (such as plastic optical fibers) and transceiver technologies. Secondly, for most structural composite applications, the required data bandwidth is relatively low. These lower bandwidth applications allow for the use of simpler and slower data encoding and transceiving methods than would be acceptable in traditional telecommunications.

A number of methods for embedding optical fibers into structural composites have already been demonstrated. The simplest and perhaps most common approach is to simply place the optical fiber between layers of preform or prepreg, physically isolating the ends (such as extending the fiber ends well beyond the nominal part dimension), and then processing the preform or prepreg into a composite through conventional means. This approach is labor intensive, inconsistent, and difficult to scale to manufacturing settings. Schuster et al. [10] demonstrate the semi-automatic incorporation of optical fibers into a woven fabric, using a lab-scale fabric weaver. The weaver is computer controlled, but requires operator intervention to switch between optical fibers and structural yarns during the weaving process. Furthermore the size, speed, and cover factor for the fabric production process were significantly less than commercial weaving operations. Bogdanovich et at [II] have demonstrated an automated approach for producing 3d-woven preforms with incorporated optical fibers. However, these preforms are not of the traditional plain-woven architecture, and instead consist of unidirectional plies stitched together into 0/90 orientations. The minimal crimp in these fabrics significantly simplifies optical fiber handling during weaving.

The present invention relates to a method of producing an optical yarn, that is, a fiberglass yarn containing an optical fiber, which could be used in weaving processes to produce woven composites with embedded optical fiber,

### 2. Materials and Methods

2.1 Optical fiber The Infiniband™ Coming (Coming, N.Y.) multimode optical fibers used in this work consist of a 125 μm glass optical fiber with a 62.5 μm core. A protective acrylate coating brings the total fiber diameter to 250 μm.

2.2 Structural glass fiber S-glass structural glass fibers were used in this study. E-glass fibers consist of alumina-calcium borosilicate glasses, and are used as general purpose fibers where strength and high electrical resistivity are required. S-glass consists of magnesium aluminosilicate glasses and, although more expensive, offer higher strength, stiffness, thermal stability, and chemical resistance than E-glass fibers.

2.3 Optical connectivity measurements For all preform and composite fiber optic connectorizations, non-polishing connectors from L-Com (Worth Andover, Mass.) were used. To connectorize, the plastic coating on the optical fiber was removed using a flame, followed by cleaning the bare optical fiber with alcohol wipes and cleaving the end to obtain a perfect flat cut. The fiber was then inserted into the connector, which contains a ferrule that has a polished optical fiber built into it. A clamping mechanism built into the connector ensures good mating of the optical fiber with the internal ferrule.

Optical loss measurements were made using a commercial fiber optic test kit manufactured by Promax, consisting of a transmitting laser and a detector unit that measures power in dBm (10 log₁₀[P(mW)]). Optical losses were referenced to the loss of a precision optical fiber jumper that was made using polished connectors. For all experiments the system used a light wavelength of 1.3 μm.

### 3. Inclusion of Optical Fiber into Optical Yarn

A brief review of yarn production and weaving methods is presented here. Individual glass filaments are produced by drawing molten glass through a heated die, called a “bushing”. Immediately after removing the filaments from the bushing, they are coated with sizings which improve handling ability and chemical compatibility with polymer matrices. The sized filaments are immediately wound onto a roll. This spool of material is called a “single-ended bundle”. Different weight single-ended bundles can be produced by using larger bushings and/or pulling more filaments from the bushing. As the filament package linear weight increases, bundles are referred to as “rovings” and, at even higher weights, as “yarns”. The package weight can also be increased by combining individual single-ended bundles into a single roving package. This combined roving is called a “multi-ended roving”. Since the sizing packages were applied individually to each bundle, the bundles are not physically adhered together in any way, so the roving has a tendency to splay and separate if not handled carefully.

Inclusion of optical fiber into fiberglass yarn was constructed by combining twenty-nine individual, single-ended S-2 Glass® fiber bundles with one optical fiber.

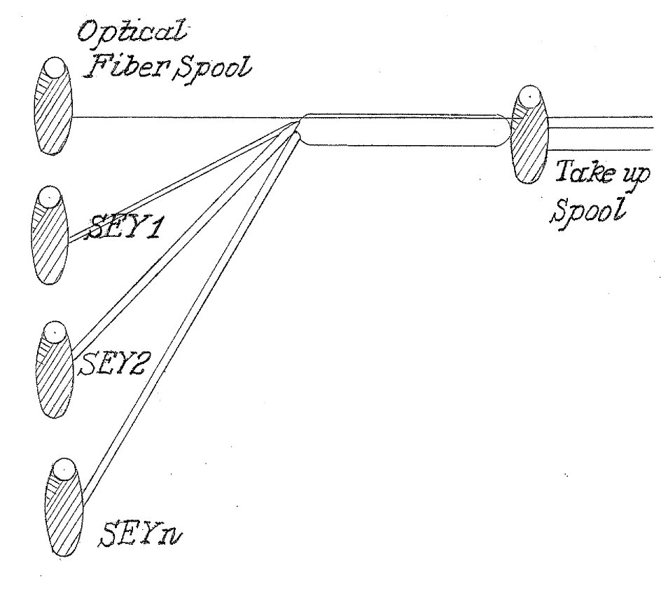

A 1 km spool was fabricated in a single, automated step by using a conventional yarn spooling apparatus. FIG. 1 shows the schematic of optical yarn construction. Linear production speeds were 1.52 m/sec. As shown in the drawing single ended yarn (SEY) from individual spools 1,2 . . . n are wound onto a take up spool simultaneously with the winding of an optical fiber from the optical fiber spool so as to create a fiber bundle comprising a fiberglass yarn containing an optical fiber and a plurality of individual glass fibers. The specific number of individual glass fibers would be dependent on the desired characteristics of the resultant optical yarn. As later discussed the optical yarn could contain, for example, both glass and plastic optical fibers. With simple modifications to the spooling assembly, production rates up to 5.08 m/sec could be reached. We will refer to this yarn as an “optical yarn”.

### 4. Optical Transmission Measurements

The complete 1 km optical yarn spool was connectorized at its ends and measured for transmissivity. Initial measurements showed no transmissivity, indicating a break in the optical fiber. However, after removing 3.048 m from one end of the yarn, and reconnectorizing, transmission through the spool with 0.04 dB loss was demonstrated. It is likely that a certain portion of this loss is associated with the curvature of the fiber, which was wound on a ˜7.5 cm spool during transmission measurements.

### 5. Extensions of the Technology

The specific embodiments of the technology documented above represent only a limited portion of the technological possibilities for this optical yarn material and its fabrication. Optical yarns can be produced using both glass and plastic optical fibers. Optical yams can be produced using structural fibers other than glass, such as but not limited to, carbon fiber, Nylon, aramid (e.g. Kevlar, Twaron), ultrahigh molecular weight polyethylene (UHMWPE, e.g. Spectra or Dyneema), polybenzoxazole (PBO, e.g. Zylon). Optical fibers can be included into yarns containing continuous filaments or discontinuous filaments (e.g. staple yarns). Optical yarns can be farther processed into more complex materials, such as woven textiles, non-woven fabrics (such as needle-punched fabrics or felts), braided ropes, or as a core in an over-braided cable. Sheathing or impregnated polymers or elastomers can also be incorporated into the optical yarn to increase its mechanical toughness or environmental durability.

What is claimed is:

1. In a method for embedding optical fibers in yarns the improvement being in that an optical fiber is introduced in an automated fashion into a fiber bundle to comprise a fiberglass yarn containing an optical fiber and a plurality of individual structural fibers.

2. The method of claim 1 including forming a spool which is fabricated in a single automated step in a yarn spooling apparatus.

3. The method of claim 2 wherein a complete optical yarn spool is connectorized at its ends.

4. The method of claim 1 wherein the yarn is a fiberglass yarn and the structural fibers are glass fibers.

5. The method of claim 4 wherein the yarn further includes plastic optical fibers.

6. The method of claim 1 wherein the structural fibers are selected from the group consisting of carbon, nylon, aramid, ultrahigh molecular weight polyethylene and polybenzoxazole.

7. The method of claim 1 wherein the optical fibers are included into the yarn containing continuous filaments.

8. The method of claim 1 wherein the optical fibers are included in the yam containing discontinuous filaments.

9. The method of claim 1 wherein the optical yarn is then further processed into more complex materials.

10. The method of claim 9 wherein the more complex materials are selected from the group consisting of woven textiles, non-woven fabrics, braided ropes, and as a core in an over-braided cable.

11. The method of claim 1 wherein sheathing is incorporated into the optical yarn.

12. The method of claim 1 wherein impregnated polymers or elastomers are incorporated into the optical yarn.
